(19) United States
(12) Patent Application Publication
(10) Pub. No.: US 2012/0242604 A1
(43) Pub. Date: Sep. 27, 2012

(54) IMAGE PROCESSING APPARATUS, METHOD FOR DISPLAYING OPERATION MANNER, AND METHOD FOR DISPLAYING SCREEN

(75) Inventor: Hiroyuki Kato, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/426,904

(22) Filed: Mar. 22, 2012

Related U.S. Application Data
(60) Provisional application No. 61/466,659, filed on Mar. 23, 2011.

(51) Int. Cl. G06F 3/041

(52) U.S. Cl. 345/173

(57) ABSTRACT

An easy-to-operate image processing apparatus is provided that includes a touch panel capable of receiving operation performed in a plurality of operation manners.

The image processing apparatus according to an embodiment includes: a touch panel configured to receive operational input made by touching a screen; a display controller configured to display at least one of operation means of two types on the touch panel including an operation button and an operation region by gesture; an operational input acquiring part configured to acquire input; a determining part configured to determine a process to be performed in response to the operational input; and an operation manner display controller configured to provide guidance indication showing an operation manner that realizes performance of the process determined by the determining part, the operation manner realizing performance of the process by using an operational technique not having been acquired by the operational input acquiring part.

### CROSS-REFERENCE TO RELATED APPLICATIONS

This application is based upon and claims the benefit of priority from U.S. provisional application 61/466,659, filed on Mar. 23, 2011; the entire contents of which are incorporated herein by reference.

### TECHNICAL FIELD

Embodiments described herein relate generally to a method for setting conditions of image processing in an image processing apparatus.

### BACKGROUND

Conventionally, a user is allowed to make various operations including setting of image processing on an image processing apparatus such as an MFP (multi-function peripheral) by operating a touch panel. On the touch panel, there are displayed buttons with which corresponding settings are made such as setting to determine the number of pages of a document to be allocated to one sheet (Nin1 setting) and setting to determine the number of sheets to be printed. A user can perform setting operations of respective setting items by touching the corresponding buttons.

Some touch panels functioning as operational input means receive entry of operational input by gesture. However, these touch panels do not always receive entry of operational input in the most suitable, manner if operation with a button and operation by gesture are both feasible on the touch panels.

### DESCRIPTION OF THE DRAWINGS

FIG. 1 is a block diagram illustrating the configuration of a system including an image forming apparatus functioning as an image processing apparatus and a client terminal that is a computer;

FIG. 2 is a functional block diagram of an image forming apparatus of a first embodiment;

FIG. 3 is an example of a screen displayed on a touch panel;

FIG. 4 shows an example of a screen showing how operational input is made in a different operation manner;

FIG. 5 shows an example of a screen showing operation with a button to make setting while operation is also made by gesture to make the same setting on the touch panel;

FIG. 6 shows an example of a screen showing operation by gesture corresponding to press of a staple setting button to make staple setting;

FIG. 7 is a flowchart explaining the flow of procedure to show a different operation manner;

FIG. 8 is a functional block diagram of an image forming apparatus of a second embodiment;

FIG. 9 shows an exemplary data structure in an operation information DB;

FIG. 10 shows an example of a screen displayed on a touch panel if an operational skill level information acquiring part acquires information indicating that a user has a higher skill level in operation by gesture;

FIG. 11 shows an example of a screen displayed on the touch panel if it is determined that a user has a higher skill level in operation with a button; and

FIG. 12 is a flowchart illustrating the flow of procedure to control display on the touch panel.

### DETAILED DESCRIPTION

An image processing apparatus according to an embodiment includes a touch panel, a display controller, an operational input acquiring part, a determining part, and an operation manner display controller. The touch panel receives operational input made by touching a screen. The display controller displays at least one of operation means of two types on the touch panel including an operation button and an operation region by gesture. The operation button allows operation to perform a predetermined process by being touched and selected on the touch panel. The operation region by gesture allows operation to perform a predetermined process in response to corresponding predetermined gesture operation performed by touch of the touch panel. The operational input acquiring part acquires input through an operation button on the touch panel, or gesture input made by the gesture operation. The determining part determines a process to be performed in response to the operational input acquired by the operational input acquiring part. The operation manner display controller provides guidance indication showing an operation manner that realizes performance of the process determined by the determining part. The operation manner realizes performance of the process by using an operational technique not having been acquired by the operational input acquiring part. The operational technique is one of two operational techniques including the input through the operation button and the gesture input.

An image processing apparatus of an embodiment also includes a touch panel, a display controller, an operational input acquiring part, a user information acquiring part, a skill level information acquiring part, and an operation means display controller. The touch panel receives operational input made by touching a screen. The display controller displays a screen on the touch panel. The screen shows operation means of two types including an operation button and an operation region by gesture. The operation button allows operation to perform a predetermined process by being touched and selected on the touch panel. The operation region by gesture allows operation to perform a predetermined process in response to corresponding predetermined gesture operation performed by touch of the touch panel. The user information acquiring part acquires user information for identifying a user. The skill level information acquiring part acquires skill level information indicating which one of operations made by operation means including operation with the operation button and operation in the operation region by gesture is operation that is performed by the user at a higher skill level. The skill level information is stored in a predetermined storage area in association with the user information. The operation means display controller gives operation means to be displayed with a high priority on the basis of the skill level information acquired by the skill level information acquiring part. The operation means to be displayed is determined to provide a higher skill level of the user.

Embodiments are described below with reference to the drawings.

### First Embodiment

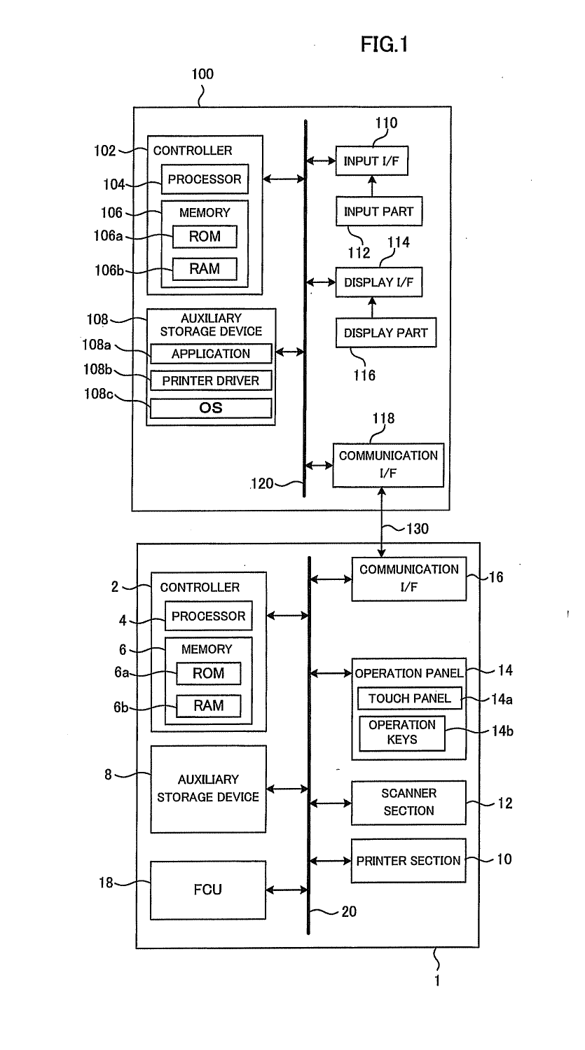

FIG. 1 is a block diagram illustrating the configuration of a system including an image forming apparatus 1 functioning as an image processing apparatus and a client terminal 100 that is a computer.

The image forming apparatus 1 is an MFP (multi-function peripheral) having a plurality of functions such as copying, scanning, and facsimile transmission. The image forming apparatus 1 includes a controller 2, an auxiliary storage device 8, a printer section 10, a scanner section 12, an operation panel 14, a communication interface (communication I/F) 16, and a facsimile control unit (FCU) 18. The respective components of the image forming apparatus 1 are connected through a bus 20.

A processor 4, a memory 6, and an operating system (OS) can constitute the controller 2.

The processor 4 is a CPU (central processing unit) or an MPU (micro processing unit).

The memory 6 is a semiconductor memory, for example. The memory 6 includes a ROM (read-only memory) 6a storing a program for controlling the processor 4, and a RAM (random-access memory) 6b functioning as a temporary work area for the processor 4.

The controller 2 controls the printer section 10, the scanner section 12, the operation panel 14, the communication I/F 16, the FCU 18 and others on the basis of the control program and the like stored in the ROM 6a or the auxiliary storage device 8. The controller 2 may also have various functions for image processing. The controller 2 may include an ASIC (application specific integrated circuit) realizing some or all of the functions of the image forming apparatus 1.

The auxiliary storage device 8 stores an application program and the OS. The application program includes a program for realizing the functions of the image forming apparatus 1 including functions as a copying function, a printing function, a scanning function, a facsimile function, and a network filing function. The application program further includes an application prepared for a web client (web browser) and others.

The auxiliary storage device 8 stores image data generated by reading an original at the scanner section 12, data acquired from external equipment connected to the communication I/F 16, and other data. The auxiliary storage device 8 temporarily stores a print job output from the client terminal 100 connected to the image forming apparatus 1 through a network 130 until printing of the print job is executed.

The auxiliary storage device 8 may be a magnetic storage device such as a hard disk drive, an optical storage device, or a semiconductor storage device (such as a flash memory). These storage devices may be combined arbitrarily to form the auxiliary storage device 8. The auxiliary storage device 8 stores software update, a protected electronic document, data in text format, account information, policy information, and other information appropriately.

The printer section 10 receives an image acquired by reading an original at the scanner section 12 or an image transmitted through the network 130 from an external computer such as the client terminal 100, for example, and forms the received image on a sheet. For example, the printer section 10 is composed of a processing unit, a transfer unit for transferring a toner image onto a sheet, and a fixing unit.

The scanner section 12 includes a scanning and reading unit provided inside the scanner section 12 and which reads a document as an image, a document placement table, and an automatic document feeder for carrying a document to a position at which the document is read. The scanning and reading unit of the scanner section 12 reads a document placed on the document placement table or the automatic document feeder.

The operation panel 14 includes a touch panel 14a and various operation keys 14b. Substances of settings relating to printing conditions including, for example, setting to determine a sheet size, the number of copies to be made or a print density, Nin1 setting, or finishing (binding and folding) is shown on the touch panel 14a. The operation keys 14b, for example, include a numeric keypad, a reset key, a stop key, a start key, and the like. As an example, a user can give instructions to execute various processes, or can set a printing condition or change a printing condition by making the corresponding operational inputs through the touch panel 14a or the operation keys 14b.

In the first embodiment, operation to make setting such as setting of a printing condition can be performed on the touch panel 14a in two operation manners (operation means) including operational input made by pressing a button displayed on a screen on the touch panel 14a, and operational input made by predetermined operation by gesture on the touch panel 14a (predetermined operation by touch on a touch panel).

In the first embodiment, “gesture” (or “gesture operation” or “gesture input”) on the touch panel 14a is a method for making operational input that allows performance of a process (such as setting of Nin1 printing) in response to particular operation by touch linked to the process and made on the touch panel 14a. Examples of the particular operation by touch may include operation of making sliding movement of a finger or a stylus pen while the finger or the stylus pen touches a specific position on a screen, operation of simply touching a region (accompanying no sliding movement) capable of receiving operation by gesture, and operation of touching a place with two fingers, and zooming the place in or out. Accordingly, operation by gesture (or gesture operation or gesture input) mentioned in the first embodiment does not include operation made by touching a button displayed on the touch panel 14a. Instructions to perform a target process can be given by a series of operations by touch that is performed as operation by gesture. Accordingly, one can perform operation to set a printing condition promptly if he or she is familiar with operation by gesture.

When setting operation to be performed by touching a button on the touch panel 14a is performed, the function of the button is generally shown on the button. Accordingly, this setting has an advantage in that the substance of operation to be performed in response to press of the button can be predicted easily. In some cases, the aforementioned setting involves press of buttons a plurality of times in order for a button corresponding to intended setting to appear. This may increase the number of times of operations, requiring more work than gesture. (For example, 4in1 setting requires touch of a button to make Nin1 setting, and thereafter, touch of a 4in1 button displayed together with other buttons such as a 2in1 button in response to touch of the Nin1 button. Meanwhile, if gesture to make 4in1 setting is registered, 4in1 setting can be finished with one operation by gesture.)

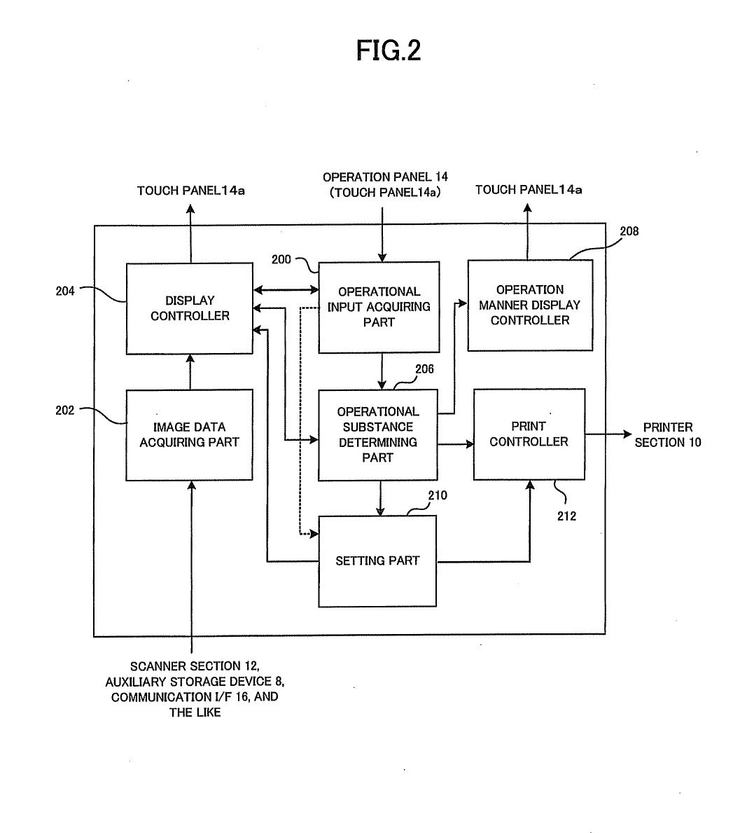

A processing method performed to realize operation by gesture of the first embodiment will be described in detail in the description of the functional blocks of the image forming apparatus 1 shown in FIG. 2.

The communication I/F 16 is an interface to make connection between the image forming apparatus 1 and the client terminal 100 through the network 130. In FIG. 1, only the client terminal 100 is shown to be connected to the image forming apparatus 1 through the network 130. Meanwhile, a different computer may also be connected to the communication I/F 16 through the network 130. Different external equipment may also be connected directly to the communication I/F 16. Such different external equipment may be an external storage device such as a flash memory. The image forming apparatus 1 can perform what is called direct print according to which an image is printed directly after image data corresponding to the image is acquired from an external storage device.

The communication I/F 16 is connected to external equipment via suitable wireless communications conforming to standards such as IEEE 802.15, IEEE 802.11, IEEE 802.3, and IEEE 1284 by using Bluetooth (registered trademark), or connections with light rays or infrared rays, or via wire communications through a USB and the like. The communication I/F 16 includes a buffer, and temporarily holds part or all of data received through the network 130 in the buffer.

The controller 2 communicates with a PC such as the client terminal 100 or different external equipment through the communication I/F 16 and the network 130.

The facsimile control unit (FCU) 18 controls transmission and reception by facsimile in the image forming apparatus 1.

Referring next to the client terminal 100, the client terminal 100 includes a controller 102, an auxiliary storage device 108, an input interface (input I/F) 110, an input part 112, a display interface (display I/F) 114, a display part 116, and a communication interface (communication I/F) 118. The respective components of the client terminal 100 are connected through a bus 120. A PC (personal computer), a portable terminal, or a tablet terminal is applicable as the client terminal 100.

A processor 104 composed of a CPU or an MPU, a memory 106, and an OS 108c put the controller 102 into operation.

The processor 104 executes an application 108a stored in the auxiliary storage device 108 (or the memory 106). The processor 104 further executes a printer driver 108b to perform a process to generate a print job on the basis of data targeted for printing. The processor 104 transmits the generated print job to the image forming apparatus 1 through the communication I/F 118 and the network 130.

The memory 106 is a semiconductor memory, for example. The memory 106 includes a ROM (read-only memory) 106a storing a program for controlling the processor 104, and a RAM (random-access memory) 106b functioning as a temporary work area for the processor 104.

The auxiliary storage device 108 stores the application program 108a, the printer driver 108b, and the OS 108c that is a program for controlling the processor 104.

The application program 108a functions as software of the OS 108c. The application program 108a includes generally used software such as software for document creation, and additionally, a web application.

The printer driver 108b is a device driver that instructs the image forming apparatus 1 to perform printing in response to instructions for printing given from the application program 108a. The printer driver 108b functions as software of the OS 108c.

The auxiliary storage device 108 having the aforementioned functions may be a hard disk drive or a different magnetic storage device, an optical storage device, or a semiconductor storage device such as a flash memory. These storage devices may be combined arbitrarily to form the auxiliary storage device 108.

The input I/F 110 is an interface making connection to the input part 112. Input devices including a keyboard, a pointing device such as a mouse, and a touch panel are applicable as the input part 112. The input part 112 may include one, or two or more of these input devices.

The display I/F 114 is an interface making connection to the display part 116. The display I/F 114 receives data to be displayed on the display part 116 from a different component connected to the bus 120. The display I/F 114 outputs display data to the display part 116.

The display part 116 causes display data given to the display part 116 to be displayed thereon. As an example, the display part 116 is a display or a touch panel accompanying a PC and the like.

The communication I/F 118 is an interface connected to external equipment. The communication I/F 118 is connected through the network 130 to the external equipment (such as the image forming apparatus 1, a different PC, or a USE device) via suitable wireless communications conforming to standards such as IEEE 802.15, IEEE 802.11, IEEE 802.3, and IEEE 1284 by using Bluetooth (registered trademark), or connections with light rays or infrared rays, or via wire communications through a USB and the like. The controller 102 communicates with the image forming apparatus 1, a different PC, a USB device, or different external equipment through the communication I/F 118. In the first embodiment, a print job is transmitted through the communication I/F 118 to the image forming apparatus 1.

The function of the image forming apparatus 1 will be described next. FIG. 2 is a functional block diagram showing the function of the image forming apparatus 1 of the first embodiment.

The image forming apparatus 1 includes an operational input acquiring part 200, an image data acquiring part 202, a display controller 204, an operational substance determining part 206, an operation manner display controller 208, a setting part 210, and a print controller 212 functioning as an image processing controller. These functional blocks are realized by execution of a program stored in the memory 6 or the auxiliary storage device 8 by the processor 4 of the image forming apparatus 1. Alternatively, some or all of the functional blocks may be realized by an ASIC as described above.

The operational input acquiring part 200 acquires various operational inputs made on the operation panel 14 (touch panel 14a and operation keys 14b). In the first embodiment, the operational input acquiring part 200 acquires various operational inputs made on the touch panel 14a. More specifically, the operational input acquiring part 200 acquires touch of a button displayed on the touch panel 14a, and operational input by gesture made on the touch panel 14a.

The image data acquiring part 202 acquires target image data when the image forming apparatus 1 performs copying or printing of the image data. In the case of copying, the image data acquiring part 202 acquires image data generated by reading of an original at the scanner section 12. In the case of printing of an image already stored as image data, the image data acquiring part 202 acquires image data targeted for printing from a flash memory connected to the communication I/F 16, from the client terminal 100, or from a different server. In the case of printing of an image stored in advance in the auxiliary storage device 8 of the image forming apparatus 1, the image data acquiring part 202 retrieves the image data from the auxiliary storage device 8.

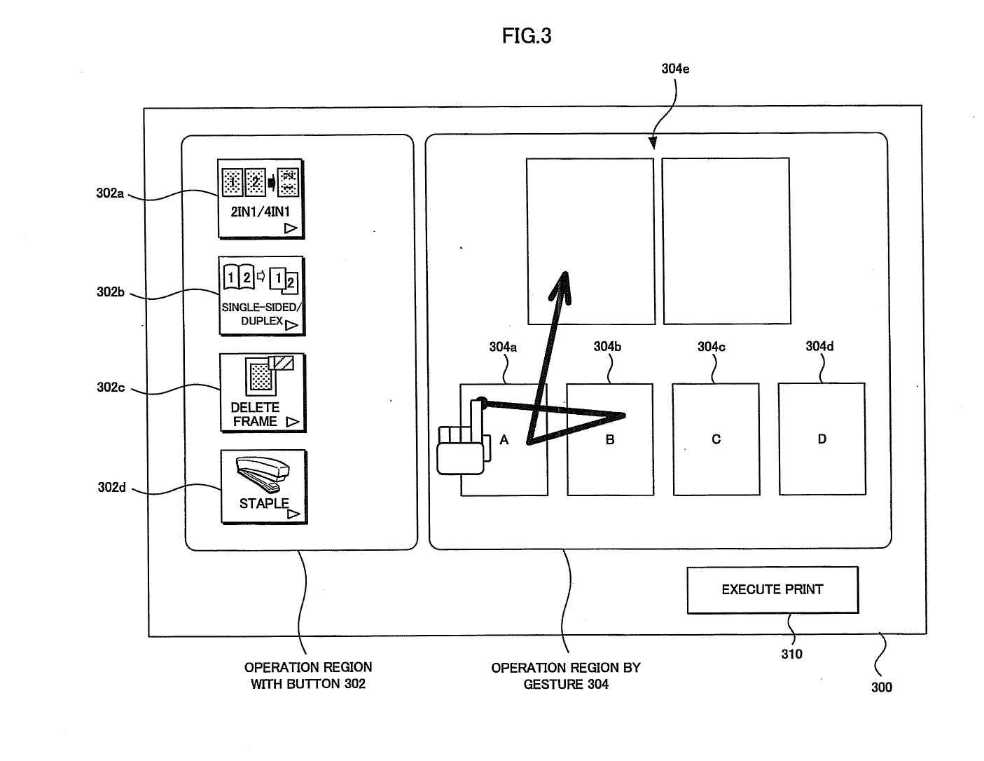

The display controller 204 controls screen display on the touch panel 14a. FIG. 3 shows an example of a screen displayed on the touch panel 14a of the first embodiment. A screen 300 shown in FIG. 3 is an example of a setting screen displayed for print setting on the touch panel 14a of the image forming apparatus 1 when the image forming apparatus 1 forms an image on the basis of a print job transmitted from the client terminal 100 to the image forming apparatus 1.

The screen 300 shown in FIG. 3 includes an operation region 302 with a button on the left and an operation region 304 by gesture on the right. Images 304a to 304d of originals A to D respectively targeted for printing are shown in a lower part of the operation region 304 by gesture. A print preview 304e is displayed in an upper part of the operation region 304 by gesture. In the example of FIG. 3, previews of two sheets (first and second pages, for example) are displayed as the print preview 304e.

The operation region 302 with a button includes an Nin1 setting button 302a, a single-sided/duplex setting button 302b, a frame deletion setting button 302c, and a staple setting button 302d. The Nin1 setting button 302a is a button pressed to make setting of Nin1 printing. The Nin1 setting button 302a shown as an example in the first embodiment only allows setting of 2in1 or 4in1 printing. The single-sided/duplex setting button 302b is a button pressed to determine single-sided printing or duplex printing. The frame deletion button 302c is a button pressed to set the function of deleting a frame (shadow) around an original generated when the original is read for copying and printing the original, for example. The staple setting button 302d is a button pressed to set a stapling process on printed sheets.

The operation region 302 with a button only allows operational input made by selection with a button. The operation region 302 with a button does not receive operation by gesture if the operation by gesture is performed on the touch panel 14a in the operation region 302 with a button.

The operation region 304 by gesture receives operational input for print setting in response to corresponding gesture registered in advance.

The screen 300 also includes a print execution button 310 with which instructions to execute printing are given. In response to touch of the print execution button 310, printing is executed on the basis of the determined print setting.

The operational substance determining part 206 determines the substance of operational input made on the operation panel 14. In particular, the operational substance determining part 206 of the first embodiment determines if operational input on the touch panel 14a was made in the operation region 302 with a button, or in the operation region 304 by gesture.

If determining that operation was made in the operation region 302 with a button, the operational substance determining part 206 determines a touched button. For example, if a display region of the Nin1 setting button 302a was touched, the operational substance determining part 206 determines that the Nin1 setting button 302a was pressed. This also applies to the case where the print execution button 310 was touched.

If determining that operation was made in the operation region 304 by gesture, the operational substance determining part 206 determines if the operation performed in the operation region 304 by gesture is one of operations by gesture registered in advance. For example, FIG. 3 shows operation of touching the currently displayed originals A and B successively with a finger while causing the finger to move slidingly, causing the originals A and B to slide into a region of one sheet shown in the print preview 304, and then releasing the finger. This operation can be registered as operation by gesture to make 2in1 setting. Accordingly, in response to performance of such operation by gesture, the operational substance determining part 206 compares the operation with the substances of operations by gesture registered in advance, thereby determining that the operation currently made agrees with the operation by gesture to make 2in1 setting. Meanwhile, if the currently made operation by gesture does not agree with any of the operations by gesture registered in advance, the operational substance determining part 206 determines that there is no operation by gesture corresponding to the currently made operation.

Operation by gesture and its corresponding substance of operation may be registered in association with each other in a dedicated database. This database may be stored in a storage device such as the auxiliary storage device 8 or the memory 6 of the image forming apparatus 1, or may be stored in a storage device of an external unit such as a server connected through the network 130.

If operational input is made on the touch panel 14a in one of the operation manners including operation with a button and operation by gesture, the operation manner display controller 208 shows on the screen 300 of the touch panel 14a how the same operational input is made in a different manner that was not employed to make the operational input. It is assumed, for example, that a user knows how to perform setting operation through operation with a button but does not know how to perform the same setting operation through operation by gesture. In this case, the user sees the aforementioned display showing operation in a different manner given by the operation manner display controller 208 to learn how to make the same operational input through operation by gesture.

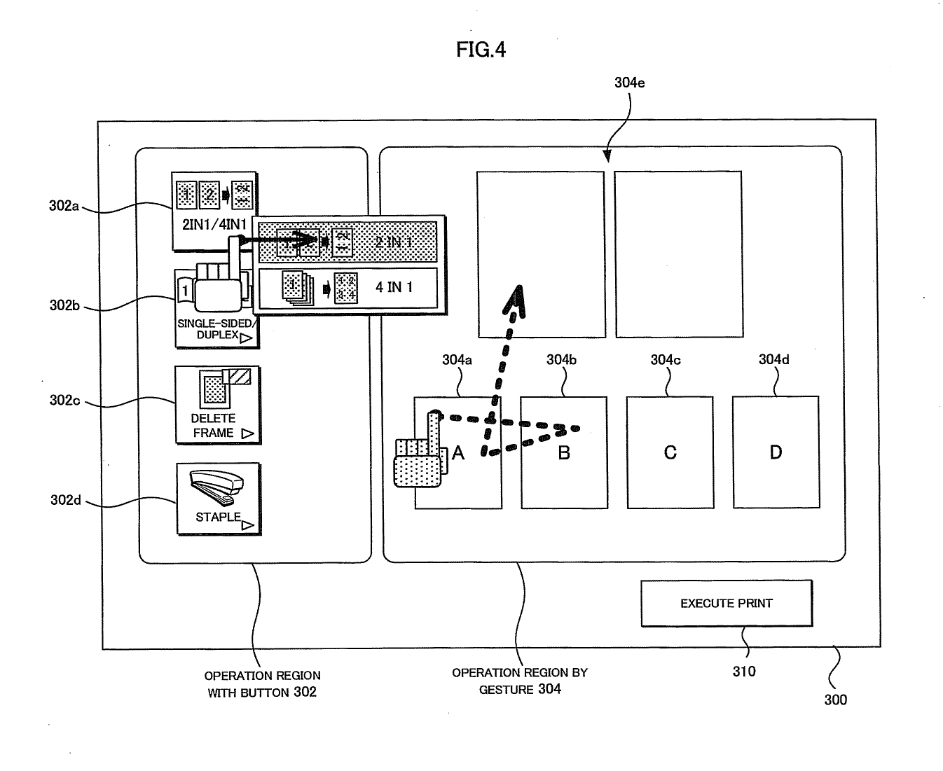

FIG. 4 shows an example of a screen of the first embodiment showing how operational input is made in a different operation manner.

FIG. 4 shows a condition where 2in1 setting is made after a user touches the Nin1 setting button 302a to cause two setting buttons including 2in1 and 4in1 setting buttons with which Nin1 setting can be made to be displayed thereon, and then slides a finger onto the 2in1 setting button to touch the 2in1 button. In this case, the operation manner display controller 208 shows in the operation region 304 by gesture how 2in1 setting is made through operation by gesture. More specifically, as shown in FIG. 4, the operation manner display controller 208 shows a series of operations including touch of the originals A and B with a finger, movement of the finger to slide the originals A and B onto a sheet shown in the print preview 304e, and release of the finger, thereby showing how the 2in1 setting is made through operation by gesture. This display is realized, for example, by showing a finger icon and a path of sliding movement of a finger in animation. Thus, a user can learn operation manners easily and correctly by referring to the setting operation performed in a different operation manner displayed on the screen.

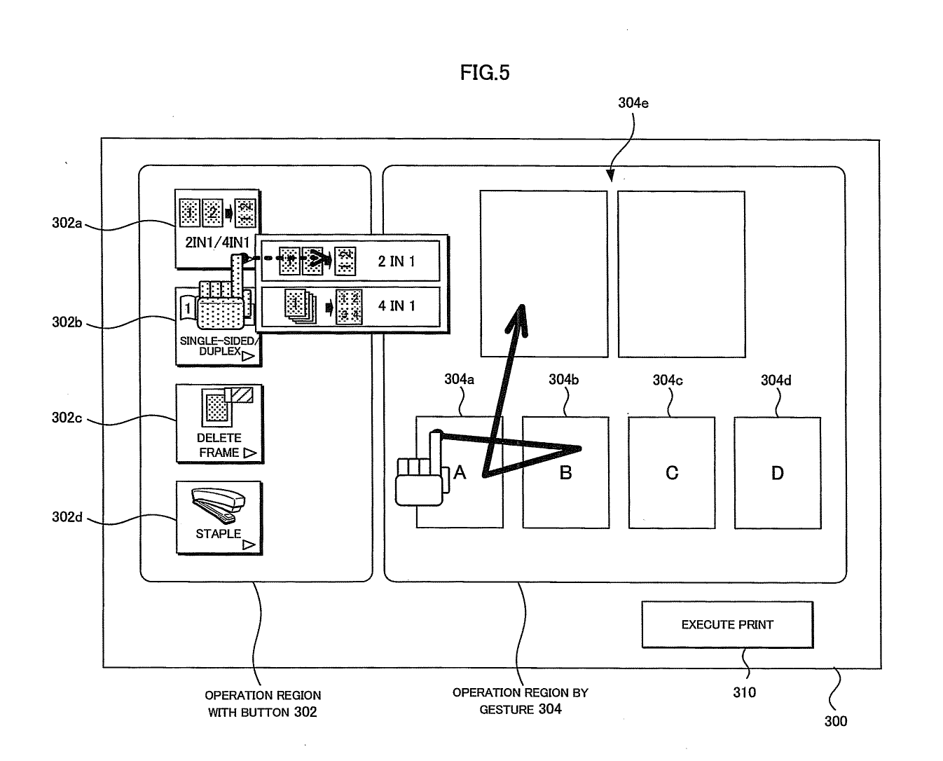

FIG. 5 shows an example of a screen, while operation is made by gesture on the touch panel 14a to make setting, the screen showing operation with a button to make the same setting. In this case, the operation manner display controller 208 also shows a series of operations with buttons in animation on the touch panel 14a.

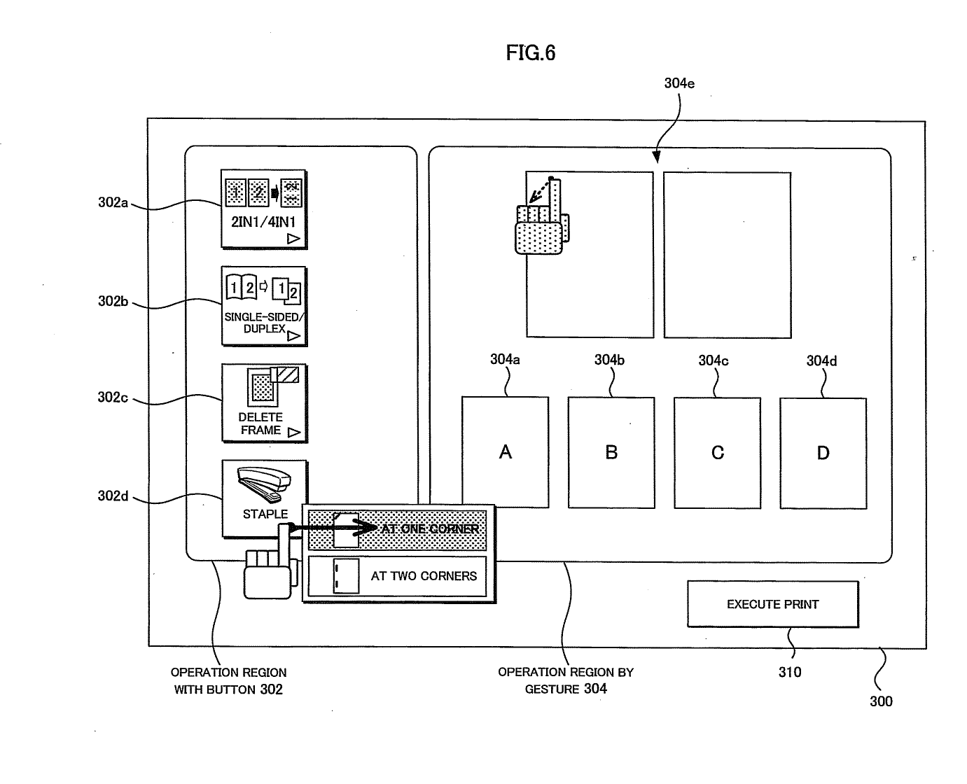

In the exemplary screen shown in FIG. 6, while staple setting is made with press of the staple setting button 302d, corresponding operation by gesture is shown in the operation region 304 by gesture. As shown in FIG. 6, if a user performs operation with a button to select stapling at one corner, the operation manner display controller 208 shows gesture of touching a corner section of a first sheet in the print preview 304e with a finger and sliding the finger, so that corresponding operation by gesture to make staple setting at one corner is shown. This allows the user to learn how to make staple setting through operation by gesture.

Data used to show a different operation manner may be stored in advance as operation manner display data into a predetermined storage area of the image forming apparatus 1. This allows the operation manner display controller 208 to acquire display data from the predetermined storage area that is used to show an operation manner corresponding to the substance of operation specified by the operational substance determining part 206. As a result, the operation manner can be displayed on the basis of the acquired data.

The operation manner display controller 208 may show a different operation manner at any time that is not specifically limited. As an example, a different operation manner may be shown at a time when a user finishes one setting operation. More specifically, when setting such as 2in1 setting and setting of duplex printing is made through operation with a button or operation by gesture, an operation manner different from the manner used to make the confirmed setting is shown. Further, after operation to make print setting such as 2in1 setting is finished and while copying or printing is performed in response to instructions to execute printing, each setting operation performed through operation with a button or operation by gesture may be shown in a different operation manner that was not used to perform the setting operation. In this case, a user can see and learn the substances of successive operations in a different operation manner together during a time waiting for completion of copying or printing.

For example, the aforementioned display of a different operation manner may be given when an operation manner learning mode is selected that is a mode dedicated to learning of an operation manner. Further, the aforementioned display may be given while normal operation to make print setting is made. In this case, it can be determined if the guidance display of an operation manner is to be given or not.

The display of a different operation manner is not necessarily given in animation but in other styles that can provide understanding of the different operation manner. The guidance display of an operation manner may be given by using one, or a plurality of still images representing the operation manner.

The operations by gesture described in the first embodiment with reference to Nin1 setting and staple setting are merely shown as examples, and operations by gesture are not limited to these exemplary operations. Operation by gesture can be set and registered freely. Further, a user can register gesture.

Referring next to the setting part 210, in response to operation to make print setting on the operation panel 14, the setting part 210 determines the setting thereby made as print setting. As an example, if the operational substance determining part 206 determines that operation to make 2in1 setting is performed through operation with a button or operation by gesture, the setting part 210 determines 2in1 setting as print setting. If the operational substance determining part 206 determines that operation by gesture performed on the touch panel 14a does not agree with any of the operations by gesture registered in advance, the setting part 210 does not make any setting.

In response to making of print setting, the display controller 204 may change display to indicate that the print setting was made. In response to making of 2in1 setting, for example, the display controller 204 allocates the images of the originals A and B to a first sheet in the print preview 304e, and allocates the images of the originals C and D to a second sheet in the print preview 304e. The display controller 204 may also indicate making of 2in1 setting by providing indication of “2in1” on the Nin1 setting button 302a, or by changing the color and the like of the Nin1 setting button 302a to highlight the Nin1 setting button 302a.

In response to instructions to execute printing, the print controller 212 controls the printer section 10 to perform a process of forming an image of image data targeted for printing. If some print setting is made in response to user's operation, the print controller 212 makes the printer section 10 perform printing on the basis of the substance of the setting.

That is one exemplary description of the functional blocks of the image forming apparatus 1 of the first embodiment.

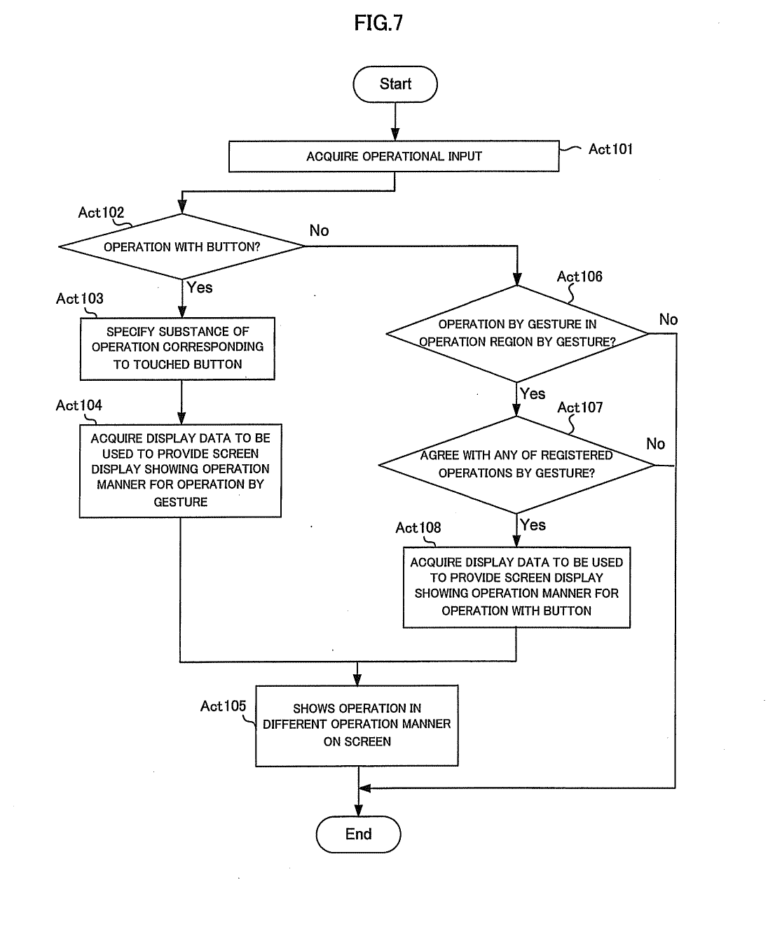

Next, the flow of display procedure of a different operation manner according to the first embodiment will be described. FIG. 7 is a flowchart showing the flow of display procedure of a different operation manner according to the first embodiment.

First, the operational input acquiring part 200 acquires operational input made on the touch panel 14a (Act 101).

Next, the operational substance determining part 206 determines if the operation acquired by the operational input acquiring part 200 is operation with a button (Act 102). More specifically, the operational substance determining part 206 determines if the acquired operation is touch of one of buttons displayed in the operation region 302 with a button, or touch of the print execution button 310.

If determining that the acquired operation is operation with a button (Act 102, Yes), the operational substance determining part 206 specifies the substance of the operation corresponding to the touched button (Act 103). If the Nin1 setting button 302a was touched and then 2in1 setting was selected, for example, the operational substance determining part 206 determines that the operational input to make 2in1 setting was given through operation with a button.

The operation manner display controller 208 acquires display data from a predetermined storage area (Act 104). The display data acquired here is used to provide screen display showing an operation manner for operation by gesture corresponding to the substance of the operation specified by the operational substance determining part 206 in Act 103.

Next, based on the display data acquired in Act 104, the operation manner display controller 208 shows guidance for operation in a different operation manner (operation by gesture) (Act 105) corresponding to the substance of the entered operational input.

If determining that the entered operation is not operation with a button (Act 102, No), the operational substance determining part 206 determines if the entered operation is operation by gesture performed in the operation region 304 by gesture (Act 106).

If determining that the entered operation is operation by gesture performed in the operation region 304 by gesture (Act 106, Yes), the operational substance determining part 206 further determines if the entered operation by gesture agrees with any of operations by gesture registered in a database stored in advance in a predetermined storage area (Act 107).

If the operational substance determining part 206 determines that there is corresponding operation by gesture (Act 107, yes), the operation manner display controller 208 acquires display data from the predetermined storage area in which the display data is stored (Act 108). The display data acquired here is used to provide screen display showing an operation manner for operation with a button corresponding to the substance of the operation by gesture determined to agree with the corresponding operation by gesture.

Next, based on the display data acquired in Act 108, the operation manner display controller 208 shows operation in a different operation manner (operation with a button) (Act 105) corresponding to the substance of the entered operational input.

Meanwhile, if the operational substance determining part 206 determines that the entered operation is not operation by gesture performed in the operation region 304 by gesture (Act 106, No), and that the entered operation is operation by gesture performed in the operation region 304 by gesture but it does not agree with operations by gesture in the database (Act 107, No), the procedure to show an operation manner is finished.

That is the description of the flow of display procedure of a different operation manner according to the first embodiment.

As in the first embodiment described above, if a user knows only one of operation with a button made by operating a button on a touch panel and operation by gesture performed by gesture on the touch panel, when the user performs operation in the familiar one of the operation manners, the user can learn the corresponding operation in a different operation manner unfamiliar to the user. Thus, if an operation manner not employed is shown on a screen while the user performs setting operation for image processing such as copying in an image forming apparatus, for example, the user can learn the different operation manner while performing setting operation. This allows the user to understand the optimum operation manner and to perform operation in the optimum manner. For example, the user is allowed to select a manner that involves a smaller number of operational steps from two operation manners realizing the same setting, and to perform operation in the selected manner.

In the first embodiment, data indicating an operation manner such as print setting in a different operation manner is stored in advance in a predetermined storage area, and is retrieved when it is shown, to which the first embodiment is not intended to be limited. An image or animation of setting may be generated when the substance of the setting is confirmed, and then the image or the animation may be shown.

The aforementioned procedure of the first embodiment to show a different operation manner may be performed on the client terminal 100 connected to the image forming apparatus 1 through the network 130 when print setting is made on the client terminal 100 after the printer driver 108b is started. In this case, a screen capable of receiving operation with a button and operation by gesture to be made with a pointing device such as a mouse may be displayed on a display of the client terminal 100, and a different operation manner may be shown on the screen. Further, if the same procedure to show an operation manner as that of the first embodiment is followed in a terminal with a touch panel such as a tablet terminal, a user can learn a different operation manner on such a terminal.

The screen 300 on the touch panel 14a of the first embodiment is shown to include the operation region 302 with a button and the operation region 304 by gesture that are displayed at the same time, to which the first embodiment is not intended to be limited. Only one of the operation regions may be displayed. In response to operation performed on a displayed operation region, an operation region not having been displayed may appear on the screen 300, and thereafter, an operation manner may be shown in the operational screen not having been displayed. As an example, only the operation region 302 with a button is displayed initially. In response to operation to make 2in1 setting in the operation region 302 with a button, the operation region 304 by gesture may be displayed on the screen 300 to show how the 2in1 setting is made through operation by gesture. An operation region not having been displayed may appear in a pop-up style. Like in the first embodiment, two operation regions may be juxtaposed to each other when they are displayed, or a currently displayed operation region may be switched to an operation region not having been displayed. These manners of display allow increase of the area of an operation region displayed on an initial operational screen, so that they can be used effectively in the case where the area of a screen on the touch panel 14a is limited, for example.

### Second Embodiment

A second embodiment will be described next. The structures same as those of the first embodiment are denoted by the same reference numbers, and will not be described again.

The configuration of a system including an image forming apparatus 1 and a client terminal 100 is the same as the system configuration of the first embodiment shown in FIG. 1, and it will not be described again.

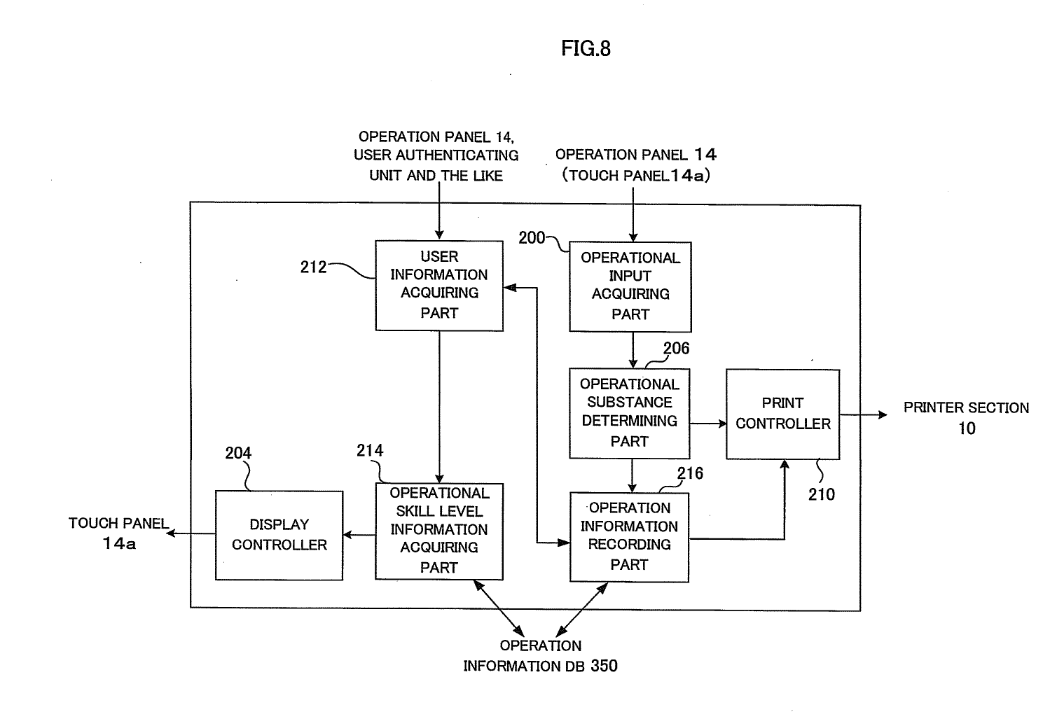

The function of the image forming apparatus 1 of the second embodiment is described next. FIG. 8 is a functional block diagram about the image forming apparatus 1 of the second embodiment. The image forming apparatus 1 of the second embodiment includes a user information acquiring part 212, an operational skill level information acquiring part 214, a display controller 204 that also functions as an operation means display controller, an operational input acquiring part 200, an operational substance determining part 206, an operation information recording part 216, and a print controller 210.

The user information acquiring part 212 acquires user information for identifying a user. The user information acquiring part acquires user information for authentication required to use the image forming apparatus 1. In the second embodiment, the user information acquiring part 212 acquires user information required to know an operational skill level registered for each user. The user information for identifying a user may be acquired during authentication process performed at the start of use of the image forming apparatus 1. The authentication process may be performed in such a manner that an authentication screen receiving entry of an input such as a user ID is displayed on a touch panel 14a, and an entry such as a user ID is made through an operation panel 14 with the touch panel 14a. The authentication process may also be performed in such a manner that an ID card is read by a card reader provided as a user authenticating unit to the image forming apparatus 1.

The operational skill level information acquiring part 214 retrieves information about a skill level of operation on the touch panel 14a registered for each user from an operation information DB 350.

The information about an operational skill level mentioned in the second embodiment is information indicating which one of two operation manners including operation with a button and operation by gesture on the touch panel 14a is an operation manner in which a user has a higher skill level. The operation information DB 350 is a database containing information about an operational skill level stored in a predetermined storage area (an auxiliary storage device 8 of the image forming apparatus 1, for example).

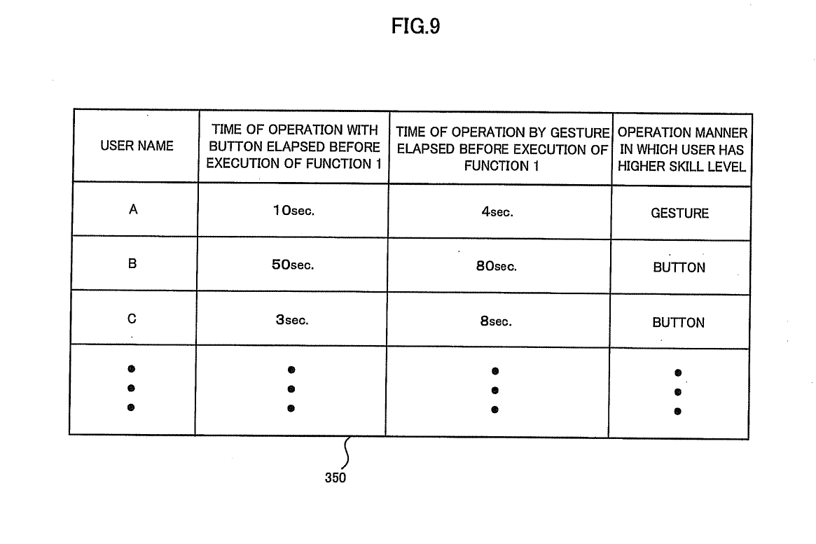

The operation information DB 350 will be described next. FIG. 9 shows an exemplary data structure in the operation information DB 350. The operation information DB 350 contains time of operation with a button elapsed before execution of a predetermined function 1, time of operation by gesture elapsed before execution of the same function 1, and an operation manner in which a user has a higher skill level determined based on the time of operation with a button and the time of operation by gesture, which are registered for each user and recorded in association with each other.

Time elapsed before execution of the predetermined function 1 is information based on which an operation manner in which a user has a higher skill level is determined. This time is more specifically time elapsed before execution of a function such as copying and printing after setting operation is made on the touch panel 14a in the image forming apparatus 1. As an example, the time elapsed before execution of the predetermined function (function 1) is time elapsed before copying is started after setting of duplex printing is made. When a user performs operation to execute the function 1, the time elapsed before execution of the function 1 is measured and registered into the operation information DB 350 by the operation information recording part 216 described later.

The time elapsed before execution of the predetermined function 1 may be determined by retrieving the latest data from the operation information DB 350. Alternatively, this time may be an average of times measured previously, or may be the shortest or longest time of the previously measured times.

Based on information about an operational skill level acquired by the operational skill level information acquiring part 214, the display controller 204 gives an operation region for an operation manner in which a user has a higher skill level a higher priority than an operation region for an operation manner in which a user has a lower skill level when these operation regions are displayed on the touch panel 14a. Giving an operation region to be displayed for an operation manner in which a user has a higher skill level a higher priority means displaying this operation region in a manner that makes operation in this region easy. A manner to realize preferential display is not limited. In the second embodiment, the display controller 240 displays an operation region for an operation manner in which a user has a higher skill level in a larger area than an operation region for an operation manner in which a user has a lower skill level.

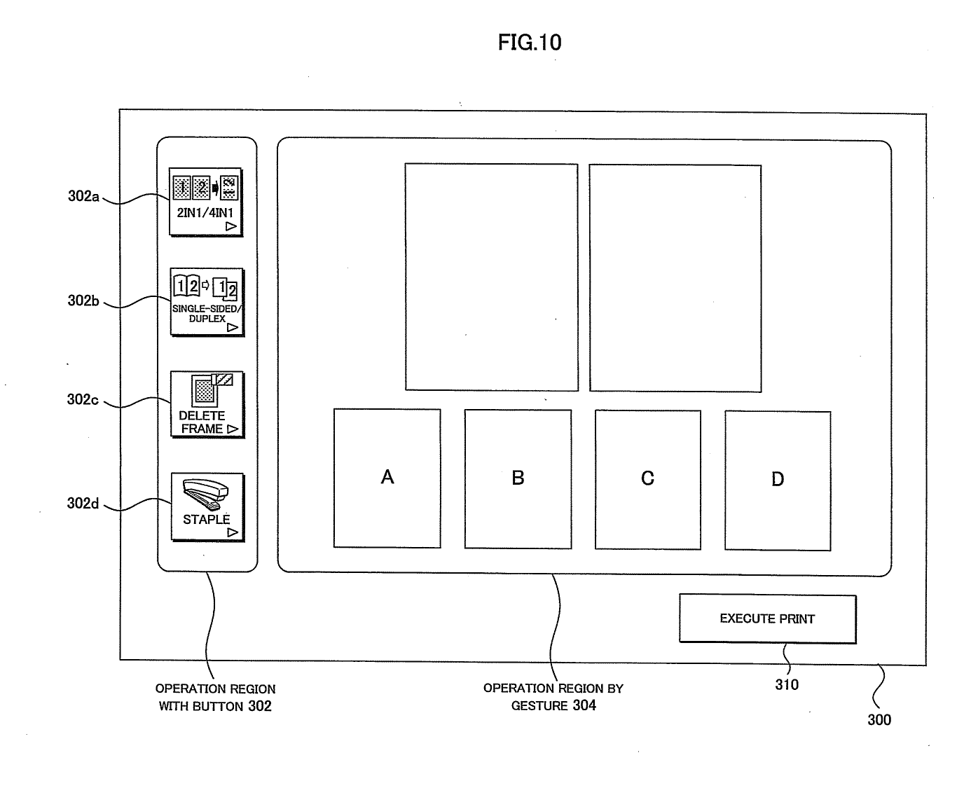

As an example, the screen shown in FIG. 10 is displayed on the touch panel 14a if the operational skill level information acquiring part 214 acquires information indicating that a user has a higher skill level in operation by gesture. FIG. 10 corresponds to the case where a user has a higher skill level in operation by gesture. Accordingly, the display controller 204 enlarges the operation region 304 by gesture on the touch panel 14a compared to that displayed in a normal condition (condition of FIG. 3, for example), and shrinks the operation region 302 with a button on the touch panel 14a compared to that shown in the normal condition.

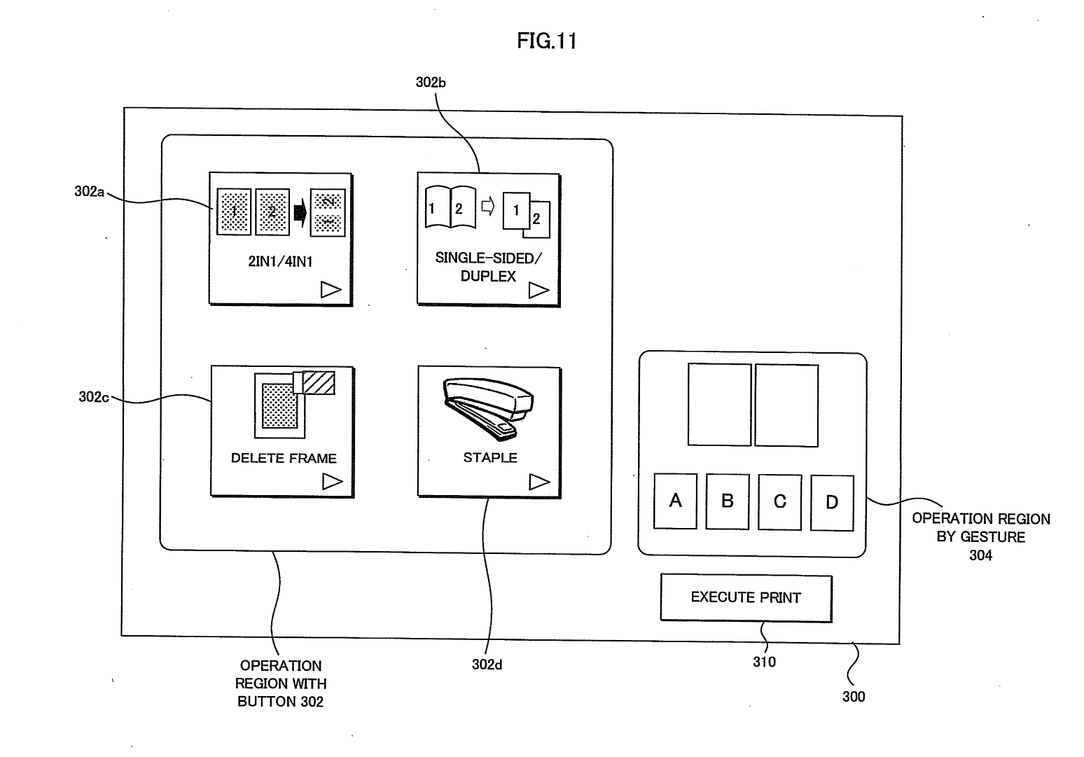

FIG. 11 shows a screen displayed on the touch panel 14a if it is determined that a user has a higher skill level in operation with a button. On the screen shown in FIG. 11, the operation region 302 with a button has a larger area than the operation region 304 by gesture.

The operational input acquiring part 200 acquires operational input from the operation panel 14 with the touch panel 14a. The operational substance determining part 206 determines the substance of the operational input acquired by the operational input acquiring part 200. The print controller 210 controls printing performed on the basis of the substance of operation acquired by the operational input acquiring part 200 and specified by the operational substance determining part 206. These three functional blocks are the same as the corresponding blocks of the first embodiment.

The operation information recording part 216 stores information (in the second embodiment, time elapsed before execution of the predetermined function 1) based on which an operation manner in which a user has a higher skill level is determined, and registers the stored information into the operation information DB 350. In response to user's operation to execute the function 1, the operation information recording part 216 measures time required for the operation based on the substance of the operation specified by the operational substance determining part 206, and registers user information acquired by the user information acquiring part 212 and the measured time in association with each other into the operation information DB 350. The measured time to be entered at this time may sequentially overwrite time having been registered to update the operation information DB 350, or may overwrite the time having been registered if it is shorter or longer than the time having been registered.

The aforementioned function of the second embodiment makes it possible to enlarge an operation region for an operation manner in which a user has a higher skill level compared to an area in a normal condition if the touch panel 14a is capable of receiving two operation manners including operation with a button and operation by gesture. A user is assumed to perform operation in an operation manner in which the user has a higher skill level. Accordingly, if an operation region for the operation manner in which a user has a higher skill level is shown in an enlarged area, the user can perform operation more easily in the manner at the higher skill level.

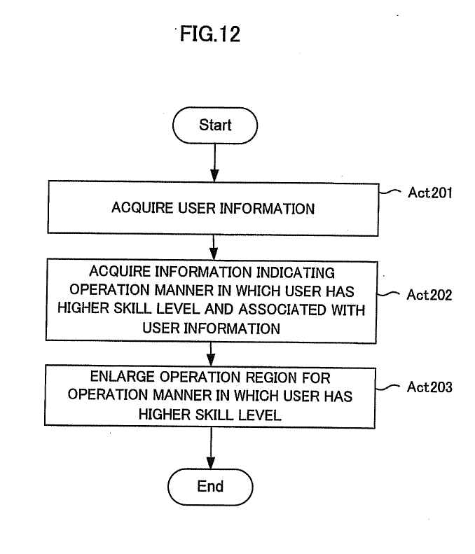

A flow of procedure to control display on the touch panel 14a according to the second embodiment will be described next. FIG. 12 is a flowchart showing the flow of the procedure to control display on the touch panel 14a according to the second embodiment.

First, the user information acquiring part 212 acquires user information for identifying a user to use the image forming apparatus 1 during authentication process required to start use of the image forming apparatus 1 (Act 201). The user information is not always acquired at the start of use of the image forming apparatus 1, but it may be acquired during change to a display mode in which an operation region being displayed is enlarged or shrunk according to the skill level described in the second embodiment.

Next, the operational skill level information acquiring part 214 retrieves information indicating an operation manner in which a user has a higher skill level and associated with the user information acquired by the user information acquiring part 212 from the operation information DB 350 stored in a predetermined storage area (Act 202).

Then, based on the information acquired by the operational skill level information acquiring part 214, the display controller 204 enlarges an operation region for the operation manner in which a user has a higher skill level and shrinks an operation region for an operation manner in which a user has a lower skill level, and then displays the operation regions on the touch panel 14a (Act 203).

That is the description of the flow of the procedure to control display on the touch panel 14a in the second embodiment.

In the second embodiment, how the display controller 204 gives the operation region for the operation manner in which a user has a higher skill level a higher priority when this operation region is displayed is described in such a manner that an operation region for an operation manner in which a user has a higher skill level is enlarged and an operation region for an operation manner in which a user has a lower skill level is shrunk when these operation regions are displayed. However, this is not the only manner of control by the display controller 204. The display controller 204 may also control such that an operation region for an operation manner in which a user has a lower skill level is not displayed, and that an operation region for an operation manner in which a user has a higher skill level is displayed in an enlarged manner throughout a screen.

Further, in the second embodiment, time elapsed by performing operation with a button before execution of a predetermined function and time elapsed by performing operation by gesture before execution of the predetermined function are used as information based on which an operation manner in which a user has a higher skill level is determined. However, this is not the only manner of determining an operation manner in which a user has a higher skill level, but an operation manner in which a user has a higher skill level may be determined on the basis of time elapsed before predetermined print setting is finished. More specifically, this is time elapsed before operation to set duplex printing is finished, or time elapsed before operation to make Nin1 setting such as 2in1 setting and 4in1 setting is finished.

Further, information used as a basis to determine an operation manner may also be a cumulative total of operations with a button and a cumulative total of operations by gesture made by each user, or a cumulative total of operations with a button and that of operations by gesture (frequencies) made by each user in a predetermined period of time. As an example, the number of times operation with a button is performed and the number of times operation by gesture is performed by each user in a month may be recorded into the operation information DB 350, and an operation manner of the larger number may be determined as an operation manner in which a user has a higher skill level. This is because the operation manner in which the user actually performed operations a larger number of times is considered as an operation manner in which a user has a higher skill level.

In the second embodiment described above, an operation manner in which a user has a higher skill level is determined based on information of one type. For example, such an operation manner is determined by comparing times elapsed before completion of one operation, or comparing the aforementioned cumulative totals. Meanwhile, an operation manner in which a user has a higher skill level may also be determined on the basis of reference information of a plurality of types. For example, operational time elapsed before execution of a function 1, and time elapsed before execution of a function 2 different from the function 1 may be measured and recorded. Then, respective averages of these two times may be calculated, and an operation manner of a shorter average time may be determined as an operation manner in which a user has a higher skill level.

Further, the second embodiment describes that the operation information DB 350 contains an operation manner in which a user has a high skill level that is determined in advance on the basis of information stored in the operation information recording part 216. However, the embodiment is not intended to be limited. The image forming apparatus 1 may include a determining part that determines an operation manner in which a user has a high operational skill level, and the determining part may determine an operation manner in which a user has a high operational skill level when a user performs operation on the touch panel 14a. Specifically, information to be used to determine an operation manner in which a user has a high operational skill level may be registered in advance into the operation information DB 350, the operational skill level information acquiring part 214 may retrieve the information, and then the determining part may determine an operation manner in which a user has a higher skill level on the basis of the retrieved information.

The operation information DB 350 is not necessarily stored in a storage area of the image forming apparatus 1, but may be stored in a storage area of an external server and the like connected through the network 130. Placing the operation information DB 350 on the network 130 allows a different image forming apparatus connected to the network 130 to make screen display on the basis of a common skill level.

The procedure to control display on a screen described in the second embodiment may be also realized in the client terminal 100. If the client terminal 100 is a terminal with a touch panel such as a tablet terminal, the client terminal 100 can perform operation to make print setting in an operation manner in which a user has a higher skill level by following the same procedure to make screen display as that described in the second embodiment. If the client terminal 100 is a terminal operated with a pointing device such as mouse, the same procedure to make screen display as that of the second embodiment may be followed with the pointing device on a screen being displayed capable of receiving operation with a button and operation by gesture.

As described in detail above, the embodiments are capable of providing an easy-to-operate image processing apparatus with a touch panel that can receive operation performed in a plurality of operation manners.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image processing apparatus, comprising:
a touch panel configured to receive operational input made by touching a screen;
a display controller configured to display at least one of operation means of two types on the touch panel including an operation button and an operation region by gesture, the operation button allowing operation to perform a predetermined process by being touched and selected on the touch panel, the operation region by gesture allowing operation to perform a predetermined process in response to corresponding predetermined gesture operation performed by touch of the touch panel;
an operational input acquiring part configured to acquire input through an operation button on the touch panel, or gesture input made by the gesture operation;
a determining part configured to determine a process to be performed in response to the operational input acquired by the operational input acquiring part; and
an operation manner display controller configured to provide guidance indication showing an operation manner that realizes performance of the process determined by the determining part, the operation manner realizing performance of the process by using an operational technique not having been acquired by the operational input acquiring part, the operational technique being one of two operational techniques including the input through the operation button and the gesture input.

2. The image processing apparatus according to claim 1, wherein
the display controller displays the operation means of two types at the same time including the operation button and the operation region by gesture, and
the operation manner display controller provides the guidance indication showing the operation manner while the operation means of two types are displayed at the same time.

3. The image processing apparatus according to claim 2, wherein, regarding the guidance indication showing the operation manner, the operation manner display controller shows the operation manner by specifying at least a position to be touched in a region in which operation means corresponding to the operational technique not having been acquired is shown, the operation manner being employed to perform the process through operation to be made by using the operational technique not having been acquired, the process being determined as a process to be performed.

4. The image processing apparatus according to claim 3, wherein the operation manner display controller provides the guidance indication in animation showing the operation manner in the region in which the operation means corresponding to the operational technique not having been acquired is shown.

5. The image processing apparatus according to claim 1, further comprising an image processing controller configured to perform image processing on target image data on the basis of the operational input acquired by the operational input acquiring part, and
wherein the operation manner display controller provides the guidance indication showing the operation manner while the image processing is performed on the target image data.

6. The image processing apparatus according to claim 1, further comprising an image processing controller configured to perform image processing on target image data on the basis of the operational input acquired by the operational input acquiring part, and wherein
the display controller displays a preview image of the target image data in the operation region by gesture, and
in response to operation performed by one of the operation means of two types to set a condition for image processing on the target image data, the display controller reflects the image processing based on the set condition in the preview image being displayed.

7. A method for displaying an operation manner, comprising:
displaying at least one of operation means of two types including an operation button and an operation region by gesture on a touch panel configured to receive operational input made by touching a screen, the operation button allowing operation to perform a predetermined process by being touched and selected on the touch panel, the operation region by gesture allowing operation to perform a predetermined process in response to corresponding predetermined gesture operation performed by touch of the touch panel;
acquiring input through an operation button on the touch panel, or gesture input made by the gesture operation;
determining a process to be performed in response to the acquired operational input; and
providing guidance indication showing an operation manner that realizes performance of the process determined as a process to be performed, the operation manner realizing performance of the process by using an operational technique not having been acquired, the operational technique being one of two operational techniques including the input through the operation button and the gestrue input.

8. The method for displaying an operation manner according to claim 7, wherein
the operation means of two types including the operation button and the operation region by gesture are displayed at the same time, and
the guidance indication showing the operation manner is provided while the operation means of two types are displayed at the same time.

9. The method for displaying an operation manner according to claim 8, wherein, regarding the guidance indication showing the operation manner, the operation manner is shown by specifying at least a position to be touched in a region in which operation means corresponding to the operational technique not having been acquired is shown, the operation manner being employed to perform the process through operation to be made by using the operational technique not having been acquired, the process being determined as a process to be performed.

10. The method for displaying an operation manner according to claim 9, wherein the guidance indication showing the operation manner is provided in animation in the region in which the operation means corresponding to the operational technique not having been acquired is shown.

11. The method for displaying an operation manner according to claim 7, wherein
image processing is performed on target image data on the basis of the acquired operational input, and
the guidance indication showing the operation manner is provided while the image processing is performed on the target image data.

12. The method for displaying an operation manner according to claim 7, wherein
image processing is performed on target image data on the basis of the acquired operational input,
a preview image of the target image data is displayed in the operation region by gesture, and
in response to operation performed by one of the operation means of two types to set a condition for image processing on the target image data, the image processing based on the set condition is reflected in the preview image being displayed.

13. An image processing apparatus, comprising:
a touch panel configured to receive operational input made by touching a screen;
a display controller configured to display a screen on the touch panel, the screen showing operation means of two types including an operation button and an operation region by gesture, the operation button allowing operation to perform a predetermined process by being touched and selected on the touch panel, the operation region by gesture allowing operation to perform a predetermined process in response to corresponding predetermined gesture operation performed by touch of the touch panel;
a user information acquiring part configured to acquire user information for identifying a user;
a skill level information acquiring part configured to acquire skill level information indicating which one of operations made by operation means including operation with the operation button and operation in the operation region by gesture is operation that is performed by the user at a higher skill level, the skill level information being stored in a predetermined storage area in association with the user information; and
an operation means display controller configured to give operation means to be displayed a high priority on the basis of the skill level information acquired by the skill level information acquiring part, the operation means to be displayed being determined to provide a higher skill level of the user.

14. The image processing apparatus according to claim 13, wherein the operation means display controller displays the operation means that is determined to provide a higher skill level of the user in an enlarged manner.

15. The image processing apparatus according to claim 13, wherein the operation means display controller does not display operation means determined to provide a lower skill level of the user.

16. The image processing apparatus according to claim 13, wherein the skill level information is time elapsed until each of the operation means including operation with the operation button and operation in the operation region by gesture finishes operation to perform one predetermined process, or information based on the time.

17. The image processing apparatus according to claim 13, wherein the skill level information is information relating to the number of times the user performs operation to realize a predetermined process by each of the operation means of two types.

18. A method for displaying an operation manner, comprising:
displaying a screen on a touch panel configured to receive operational input made by touching the screen, the screen showing operation means of two types including an operation button and an operation region by gesture, the operation button allowing operation to perform a predetermined process by being touched and selected on the touch panel, the operation region by gesture allowing operation to perform a predetermined process in response to corresponding predetermined gesture operation performed by touch of the touch panel;
acquiring user information for identifying a user;
acquiring skill level information indicating which one of operations made by operation means including operation with the operation button and operation in the operation region by gesture is operation that is performed by the user at a higher skill level, the skill level information being stored in a predetermined storage area in association with the user information; and
giving operation means to be displayed a high priority on the basis of the acquired skill level information, the operation means to be displayed being determined to provide a higher skill level of the user.

19. The method for displaying an operation manner according to claim 18, wherein the operation means that is determined to provide a higher skill level of the user is displayed in an enlarged manner.

20. The method for displaying an operation manner according to claim 18, wherein the operation means that is determined to provide a lower skill level of the user is not displayed.

21. The method for displaying an operation manner according to claim 18, wherein the skill level information is time elapsed until each of the operation means including operation with the operation button and operation in the operation region by gesture finishes operation to perform one predetermined process, or information based on the time.

22. The method for displaying an operation manner according to claim 18, wherein the skill level information is information relating to the number of times the user performs operation to realize a predetermined process by each of the operation means of two types.
